(19) United States
(12) Patent Application Publication
(10) Pub. No.: US 2011/0100561 A1
(43) Pub. Date: May 5, 2011

(54) Vertical Wiped Thin-Film Evaporator

(75) Inventors: Perry Alasti, Chestnut Hill, MA (US); James Russell Steeves, Ayer, MA (US); Craig Karl Wallace, Braintree, MA (US)

(73) Assignee: ARTISAN INDUSTRIES INC., Waltham, MA (US)

(21) Appl. No.: 12/917,317

(22) Filed: Nov. 1, 2010

Related U.S. Application Data
(60) Provisional application No. 61/257,419, filed on Nov. 2, 2009.

(51) Int. Cl. B01D 1/24

(52) U.S. Cl. 159/11.1; 159/49

(57) ABSTRACT

A vertical wiped thin-film evaporator (WFE) may be bottom fed or top fed. Some embodiments have integral entrainment separation devices. Some embodiments are configured with replaceable rotor blade cartridges to facilitate experimenting with different blade configurations, blade pitches and directions (up or down) of thin film displacement for various modes of operation. Some embodiments can be operated in either co-current or counter-current modes, without requiring modification to their “overheads” (entrainment separation, condensing and vacuum) systems. Some embodiments include a variety of feed nozzles and/or a variety of “bottoms” nozzles. The available nozzles provide flexibility in operating the device, such as selecting a mode (top feeding or bottom feeding) of operation or co-current or counter-current vapor extraction.

### CROSS REFERENCE TO RELATED APPLICATIONS

This application claims the benefit of U.S. Provisional Patent Application No. 61/257,419, filed Nov. 2, 2009, titled “Vertical Wiped Thin Film Evaporator,” the entire contents of which are hereby incorporated by reference herein, for all purposes.

### TECHNICAL FIELD

The present invention relates to wiped thin-film evaporators (WFEs), and more particularly to vertically axised wiped thin-film evaporators.

### BACKGROUND ART

It is known in the prior art to use a vertical or horizontal wiped thin-film evaporator (“WFE”) to remove a solvent from a resin, dehydrate a food product, purify an antioxidant or perform a chemical reaction in relation to processing thermally unstable, viscous, solids-containing and foaming materials. See, for example U.S. Pat. Nos. 4,160,692, 5,582,692 and 6,160,143, the entire contents of which are hereby incorporated by reference. Using a thin-film evaporator entails placing a thin film of the material being processed on an inner wall of an externally heated chamber to provide a surface for evaporation.

In a conventional vertical wiped thin-film evaporator, feed material is introduced at the top of the apparatus, a concentrated product is removed from the bottom and resulting vapor is removed from the top of the apparatus. Additionally, this vapor stream is typically sent to an external entrainment separation vessel, such as a cyclone separator, to remove any liquid or solid that may have been carried over in the vapor stream.

Conventional vertical wiped thin-film evaporators are typically capable of removing only up to about 80% of the “light ends” (solvents or other materials to be evaporated), owing to thinning of the product film due to gravitational forces. Exceeding this rate of removal in certain applications has been known to cause degradation of the product due to so-called “burn-on,” particularly when operating at reduced capacity. For certain applications, particularly, in research and development, determining an appropriate feed rate, blade rotation velocity, blade design, heat input, and other parameters of a WFE can be a time-consuming, trial-and-error process that may require repeatedly tearing down a machine to change its configuration.

### SUMMARY OF EMBODIMENTS

An embodiment of the present invention provides a vertically axised, rotary wiped thin-film evaporator (vertical WFE). The vertical WFE includes a vertically oriented vessel that defines a vertically-oriented cylindrical interior section and an interior entrainment separation section. The interior entrainment separation section is above, and in fluid communication with, the cylindrical interior section. The interior entrainment separation section has a larger cross-sectional area than the cylindrical internal portion. The vertical WFE also includes a first feed nozzle in fluid communication with the cylindrical interior portion and a first discharge nozzle in fluid communication with the cylindrical interior section. (In either case, the fluid communication may be via the interior entrainment separation section.) A jacket surrounds at least a portion of the cylindrical interior section. The jacket is configured to transfer heat between a fluid flowing through the jacket and the cylindrical interior section. At least two heat exchange fluid nozzles are in fluid communication with the jacket. A vertically-oriented shaft extends through the entrainment separation portion and the cylindrical interior portion. The shaft is configured to rotate within the entrainment separation section and the cylindrical interior section. At least one elongated rotor blade is disposed within the cylindrical interior section. The blade is aligned with, and attached to, the vertically-oriented shaft. The blade rotates with the shaft. At least one entrainment separator is disposed within the interior entrainment separation section. The entrainment separator is attached to the vertically-oriented shaft, so the entrainment separator rotates with the shaft.

The at least one entrainment separator may include a mesh, a double blade, a vane, a chevron, a labyrinth, a paddle, a ribbon blade or a twisted helical ribbon blade. The at least one entrainment separator may be detachably attached to the vertically-oriented shaft.

The first feed nozzle may be disposed higher or lower than the first discharge nozzle. For example, when bottom feeding is desired, the first feed nozzle is disposed lower than the first discharge nozzle, whereas when top feeding is preferred, the first feed nozzle is disposed higher than the first discharge nozzle.

The first discharge nozzle may be in fluid communication with the cylindrical interior portion via at least a portion of the interior entrainment separation section. That is, the first discharge nozzle may be coupled directly to the interior entrainment separation section, so bottoms product may pass through at least a portion of the interior entrainment separation portion on its way to the first discharge nozzle. The bottom of the interior entrainment separation section may be sloped downward toward the first discharge nozzle, such as to facilitate moving the bottoms product toward the first discharge nozzle or to allow for complete drainage of the product.

To facilitate either top feeding or bottom feeding, the vertical WFE may have two sets of feed nozzles and two sets of discharge nozzles. The at least one elongated blade has a top end and a bottom end. The first feed nozzle may be disposed closer to the bottom end of the elongated blade than to the top end of the elongated blade, and the first discharge nozzle may be disposed closer to the top end of the elongated blade than to the bottom end of the elongated blade. A second feed nozzle may be in fluid communication with the cylindrical interior section. The second feed nozzle may be disposed closer to the top end of the elongated blade than to the bottom end of the elongated blade. A second discharge nozzle may be in fluid communication with the cylindrical interior section. The second discharge nozzle may be disposed closer to the bottom end of the elongated blade than to the top end of the elongated blade.

A third feed nozzle may be in fluid communication with the cylindrical interior portion below the at least one entrainment separator. The third feed nozzle may be disposed closer to the top end of the elongated blade than to the bottom end of the elongated blade. The third feed nozzle may be sloped downward toward the cylindrical interior portion. A viewing glass may be attached to the third feed nozzle. The third feed nozzle maybe used to accommodate a flashing mixture, which may include a liquid and a vapor portion, ranging from about zero to about 100% liquid or vapor, typically less than about 90% vapor.

The vertically axised, rotary thin-film evaporator may include a stand. The vertically oriented vessel may be attached to the stand, so as to provide at least about 36 inches of clearance below the vertically oriented vessel. This clearance enables a 55-gallon drum to be positioned under the vertical WFE. The stand is absent any horizontal brace below about 35 inches above the base of the stand on at least one side of the stand, so the drum can be installed below, or removed from, the vertical WFE. A motor is attached to the stand and mechanically coupled to the vertically-oriented shaft to rotate the shaft. The clearance may provide sufficient room for a pump to develop sufficient Net Positive Suction Head (NPSH) to pump the product while operating under vacuum.

A vapor discharge nozzle may be in fluid communication with the interior entrainment separation portion above the at least one entrainment separator.

The at least one elongated rotor blade may include a removable blade cartridge releasably attached to the vertically-oriented shaft, such that the removable blade cartridge is replaceable without removing the vertically-oriented shaft.

An upper bearing may be rotatably attached to the vertically-oriented shaft above the at least one elongated blade. The upper bearing is configured to support at least the combined weight of the vertically-oriented shaft and the removable blade cartridge.

The at least one elongated rotor blade may include a helical section having a blade pitch greater at the top of the rotor blade than at the bottom of the rotor blade.

Another embodiment of the present invention provides a method for bottom-feeding a vertically axised, wiped thin-film evaporator. A rotor blade that is disposed within the rotary thin-film evaporator is rotated. A feed fluid is introduced into the rotary thin-film evaporator closer to a bottom end of the rotating rotor blade than to a top end of the rotating rotor blade. An inside wall of the rotary thin-film evaporator is heated. At least a portion of the feed fluid is driven up the inside wall at least partly through action of the rotating rotor blade. A bottoms product is withdrawn from the rotary thin-film evaporator closer to the top end of the rotating rotor blade than to the bottom end of the rotating rotor blade.

The rotor blade may include a helical rotor blade. The rotor blade may have a blade pitch greater at its top than at its bottom.

An entrainment separator may be attached to a common shaft with the rotor blade and disposed within the rotary thin-film evaporator. The entrainment separator may be rotated.

A vapor may be withdrawn from the rotary thin-film evaporator via a nozzle disposed higher than the entrainment separator.

### BRIEF DESCRIPTION OF THE DRAWINGS

The invention will be more fully understood by referring to the following Detailed Description of Specific Embodiments in conjunction with the Drawings, of which:

FIG. 1 is a cross-sectional view of a vertical wiped thin-film evaporator (WFE) housing, in accordance with an embodiment of the present invention;

FIG. 2 is a side view of a rotor shaft for use with the vertical WFE housing of FIG. 1, in accordance with an embodiment of the present invention;

FIG. 3 is a cross-sectional view of the vertical WFE housing of FIG. 1, with a bottom section removed and the rotor shaft of FIG. 2 installed in the housing;

FIGS. 4-9 show end and side views of three exemplary replaceable blade cartridges, in accordance with embodiments of the present invention;

FIG. 10 is a side view of the rotor shaft of FIG. 2 with the blade cartridge of FIGS. 4 and 5 mounted thereon;

FIG. 11 is a cross-sectional view of the vertical WFE housing of FIG. 1, with the rotor shaft of FIG. 2 installed in the housing and the blade cartridge of FIGS. 4 and 5 mounted on the rotor shaft;

FIG. 12 is an enlarged view of the lower part of FIG. 11;

FIG. 13 is a bottom view of a lower flange of the WFE housing of FIG. 1;

FIG. 14 is a cross-sectional view of the flange of FIG. 13 with a bottom cap attached thereto, in accordance with an embodiment of the present invention;

FIG. 15 is a cross-sectional view of the flange of FIG. 13 with a bottoms adapter attached thereto, in accordance with an embodiment of the present invention; and

FIG. 16 shows the WFE housing of FIG. 1 mounted to an exemplary frame, in accordance with an embodiment of the present invention.

### DETAILED DESCRIPTION OF SPECIFIC EMBODIMENTS

### Definitions

As used in this description and the accompanying claims, the following terms shall have the meanings indicated, unless the context otherwise requires:

A “fluid” is a substance that can be supplied via a pipe or tube. Exemplary fluids include liquid, powder, slurry, gas, vapor and combinations thereof.

A “nozzle” is a port or connection in fluid communication with an item. The nozzle may, but need not, be connected to another item. The connection can be made by any suitable structure or technique, such as flange, threaded coupling, barb, press fit, weld or solder.

According to conventional thinking, one would expect a bottom-fed wiped thin-film evaporator (WFE) to simply fill up with fed product and operate as a stirred tank, without developing a thin film, particularly with concentrated or viscous feed materials. Vertically-oriented “rising film” evaporators are known. However, these devices do not include rotating blades, possibly because bottom-feeding a WFE was not thought to yield a functional device. We have discovered that, surprisingly, bottom feeding a WFE, with appropriate blade configurations, pitches and rotational velocities, produces desirable thin films. Essentially, an appropriate combination of blade configurations, pitches and rotational velocities generates enough centrifugal force to overcome gravitational forces to create a thin film on the inside wall of the WFE and drive the film up the wall, as it is displaced by the incoming feed. In some cases, blades with non-uniform pitches along their lengths, such as blades with greater pitches near the tops of the blades, are particularly useful when bottom feeding. Blade configurations, pitches and rotational velocities may be empirically determined using the feed products to be processed, desired heat ranges and the like. For example, a “pilot” WFE configuration described herein may be used to empirically determine appropriate operating parameters and configurations.

Several embodiments of a vertical WFE are disclosed, as well as methods for operating the same. Some embodiments of the WFE are fed at the bottom, in contrast to conventional vertical WFEs, which are fed at the top. Bottom-feeding provides several advantages, including better control of residence time, less “burn-on,” superior turn-down performance and increased evaporation of volatiles. Some embodiments of the WFE have integral entrainment separation devices, which reduce or eliminate the need for a separate entrainment separator device.

A variety of feed nozzles may be provided for introducing a fluid into the WFE. A variety of “bottoms” nozzles may be used to extract “bottoms” products from the device. The available nozzles provide flexibility in operating the device, such as selecting a mode (top feeding or bottom feeding) of operation or co-current or counter-current vapor removal.

Some embodiments of the disclosed WFE are intended primarily for laboratory, pilot or development purposes, rather than production use. These embodiments may be smaller than production units and may include features that facilitate experimentation. For example, some embodiments use easily-replaceable blade cartridges, to facilitate experimenting with different blade configurations, blade pitches and directions (up or down) of thin film displacement for various modes of operation. Furthermore, some embodiments can be operated in either co-current or counter-current modes, without requiring modification to their “overheads” (entrainment separation, condensing and vacuum) systems. These embodiments can, therefore be either top fed or bottom fed. Some embodiments of the disclosed WFE may be used in production.

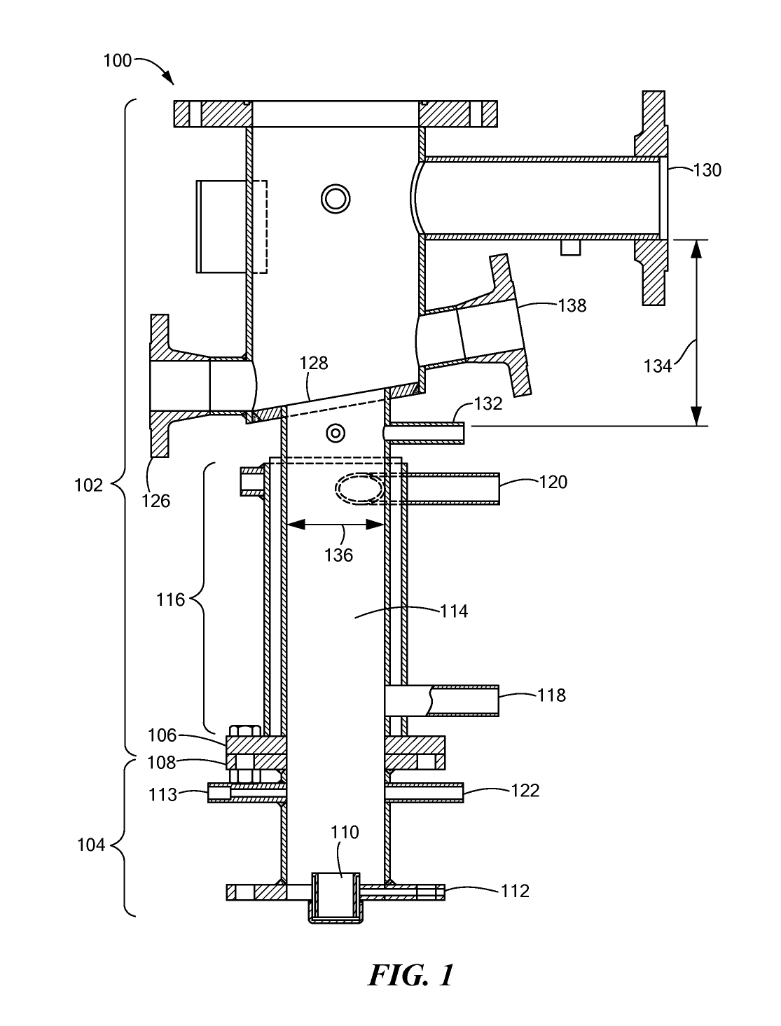

FIG. 1 is a cross-sectional view of a vertical WFE housing 100, in accordance with an embodiment of the present invention. The WFE housing 100 includes an upper section 102 and a lower section 104 that are joined together by respective flanges 106 and 108 and bolts and nuts. The lower section 104 may be easily detached from the upper section 102, to facilitate changing blade cartridges, as described below.

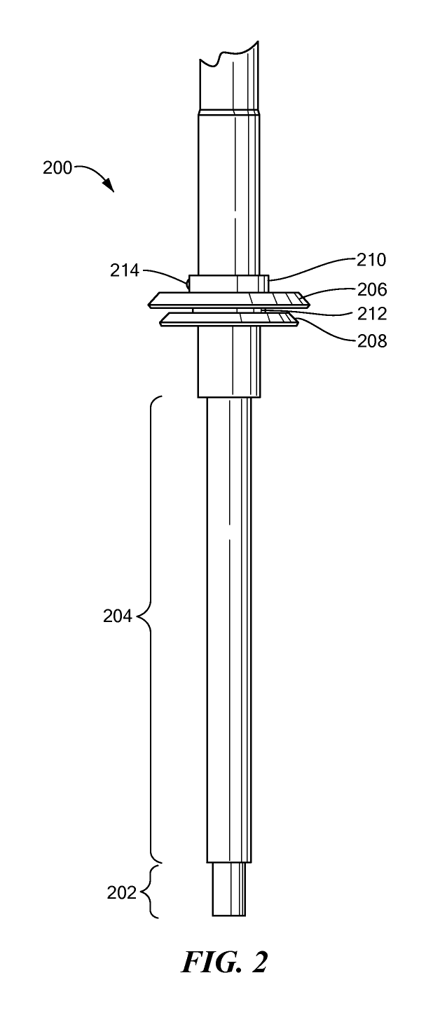

FIG. 2 is a side view of a rotor shaft 200 for use with the vertical WFE housing 100 of FIG. 1. The rotor shaft 200 includes a smaller-diameter portion 202, which is configured to be received in a bearing cup 110 (FIG. 1) in the WFE housing 100. The WFE housing 100 includes a nozzle 112, through which liquid may be injected to cool or flush the bearing 110. Additional nozzles, such as nozzle 113, may be provided to connect an external heat exchanger.

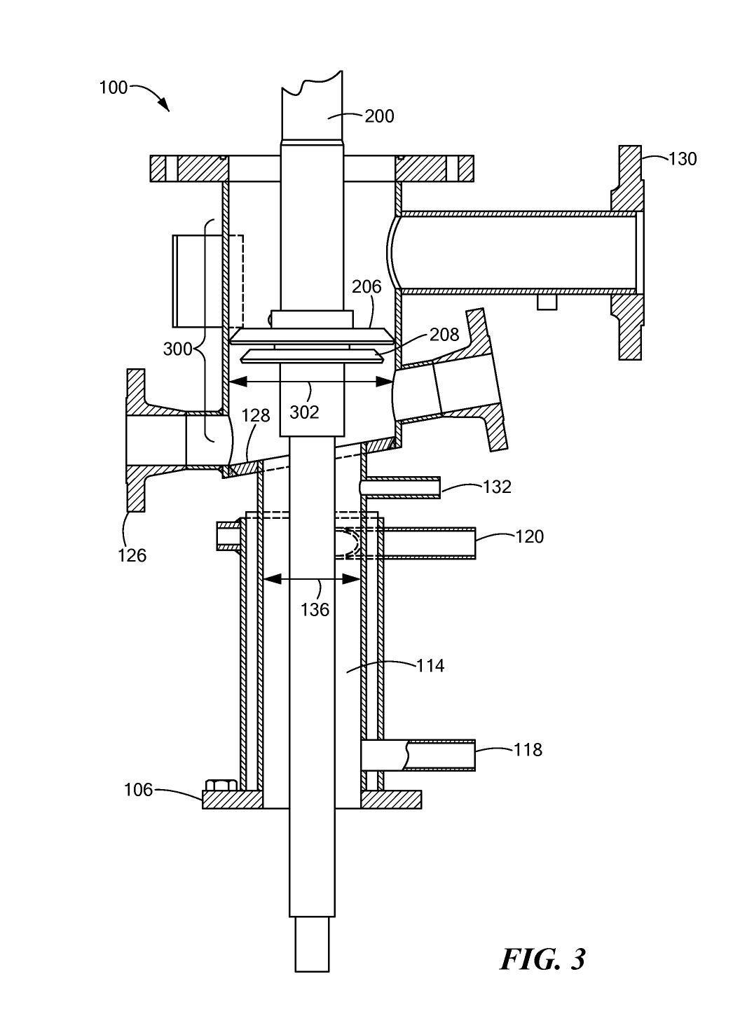

FIG. 3 shows the WFE housing 100 with the bottom section 104 removed and the rotor shaft 200 installed in the housing 100. The rotor shaft 200 is connected to a motor drive (not shown), which rotates the shaft within the housing 100. Returning to FIG. 2, the rotor shaft 200 also includes a “business” portion 204, which is sized to accept a replaceable blade cartridge.

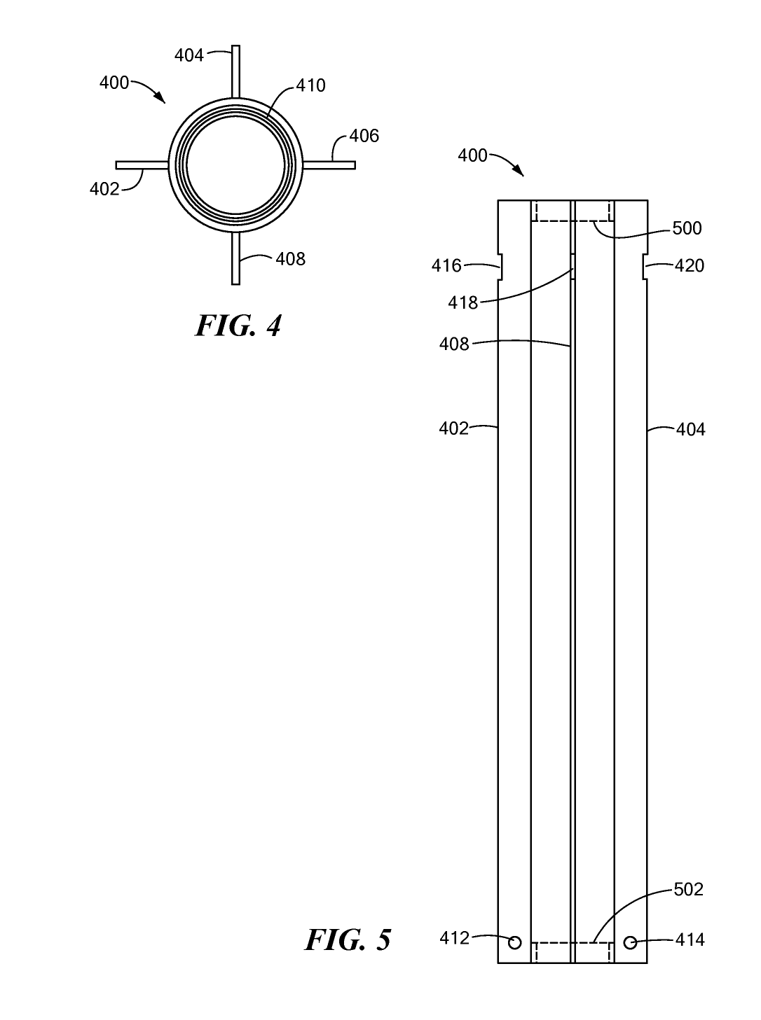

FIGS. 4-9 show three exemplary replaceable blade cartridges (rotor blades) 400, 600 and 800, respectively. FIGS. 4, 6 and 8 are end views of the blade cartridges 400, 600 and 800, and FIGS. 4, 6 and 8 are side views of the same blade cartridges. As shown, the three exemplary blade cartridges 400, 600 and 800 have respective blade configurations. For example, blade cartridge 400 has four straight blades 402, 404, 406 and 408. Blade cartridge 600 has four constant-pitch helical blades 602, 604, 606 and 608. Blade cartridge 800 has four helical blades 802, 804, 806 and 808 whose pitches vary along the length of the blade cartridge 800. Other numbers of blades and other blade configurations can, of course, be used. For example, some blade cartridges may have clockwise-wound blades, while other blade cartridges may have counter clockwise-wound blades. The blade winding direction and the direction of rotation of the rotor shaft 200 determines the direction (up or down) in which product is moved within the WFE. Blade configurations are discussed in more detail below.

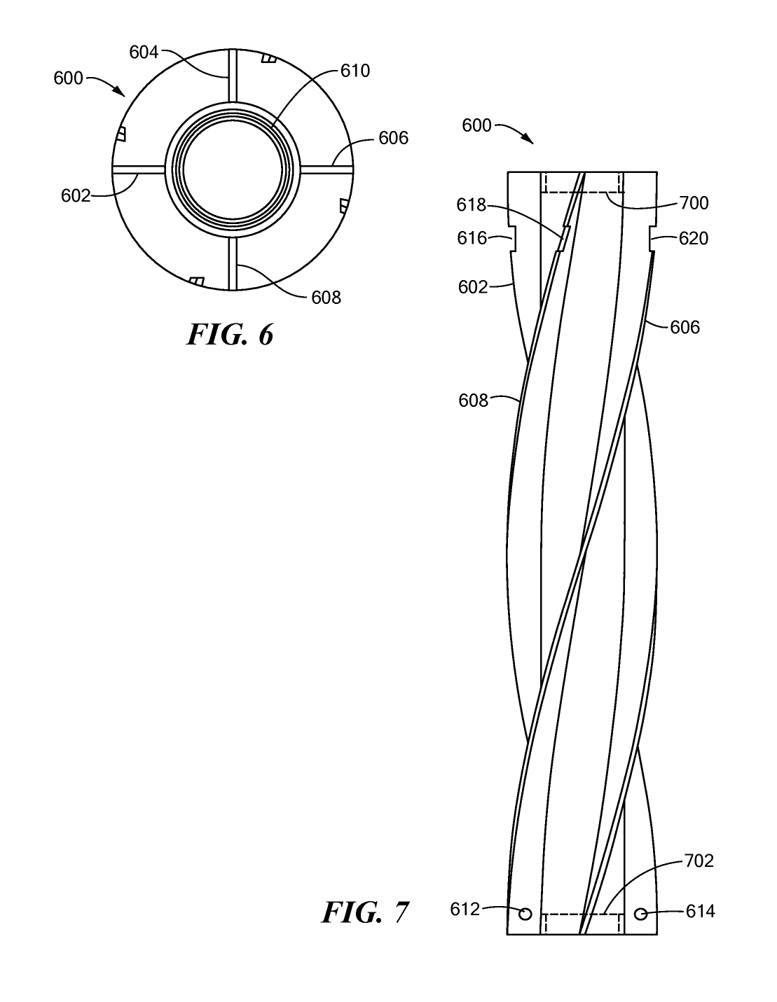

The blade cartridges 400, 600 and 800 define central bores 410, 610 and 810 whose inside diameters are slightly larger than the outside diameter of the business portion 204 (FIG. 2) of the rotor shaft 200. Upper and lower sleeve journals 500, 502, 700, 702, 900 and 902 may be press fit or otherwise installed in the blade cartridges 400-800 to define the inside diameters of the blade cartridges. A selected one of the blade cartridges 400, 600 or 800, or another blade cartridge (not shown), may be mounted coaxially on the rotor shaft 200, as shown in FIG. 10, for rotation therewith. (FIG. 10 shows the straight blade cartridge 400 mounted on the rotor shaft 200 and the following description refers to blade cartridge 400. However, as noted, any blade cartridge may be used.) The blade cartridge 400 may be removably fixed to the rotor shaft 200 by a setscrew 1000 or another suitable fastener, such as a cotter pin, snap ring or locknut.

Returning to FIGS. 5, 7 and 9, blade cartridges 400, 600 and 800 may define holes 412, 414, 612, 614, 812 and 814 near the ends of the respective blades 402, 406, 606, 602, 808 and 802 to facilitate removing the blade cartridges from the rotor shaft 200. A tool, such as a hook, may engage one or more of the holes 412-814 and, thereby, apply a pulling force sufficient to remove the blade from the rotor shaft 200 (after the setscrew 1000 or other fastener is loosened or removed).

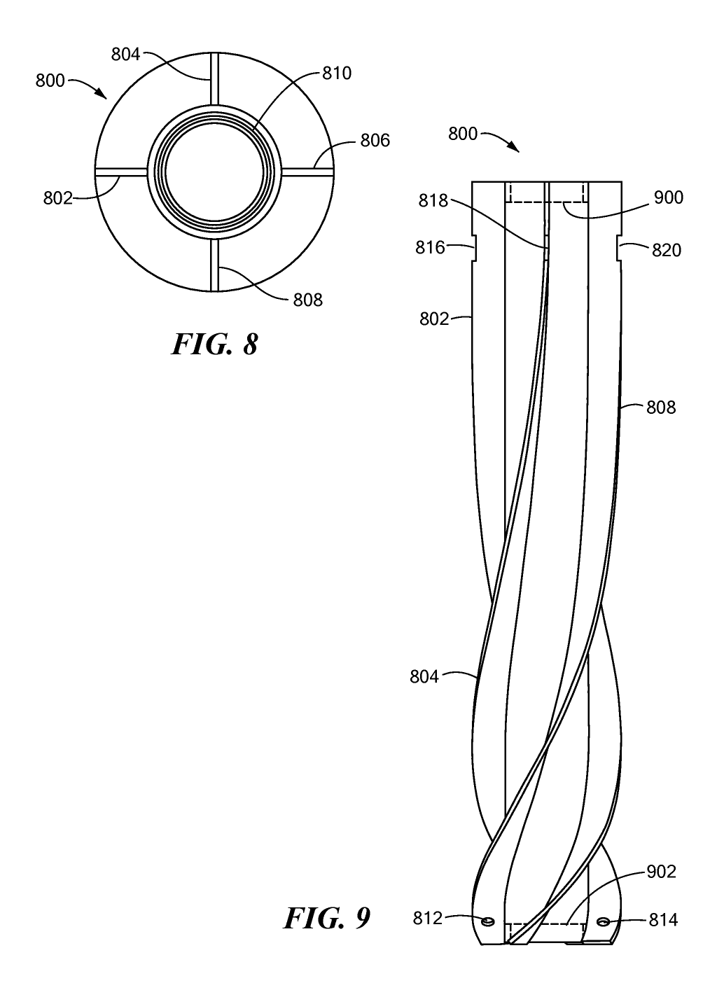

Although the blade cartridge 400 may be easily installed on, or removed from, the rotor shaft 200, the rotor shaft 200 typically remains installed in the WFE housing 100. (The rotor shaft 200, with installed blade cartridge 400, is shown in FIG. 10 separate from the WFE housing 100 merely for clarity. FIG. 3 is representative of the appearance of the vertical WFE while the blade cartridge is being replaced.) FIG. 11 shows the rotor shaft 200 and blade cartridge 400 installed in the WFE housing 100. A WFE housing 100 with a rotor shaft 200, with or without a blade cartridge, is referred to as a “WFE platform.”

The WFE housing 100 defines a shell that houses an interior chamber 114, most clearly seen in FIG. 1, in which evaporation or other desired processing occurs. It is on the inside surface of this chamber 114 that most or all of the evaporation occurs. The housing 100 includes a jacketed portion 116 surrounding at least a portion of the chamber 114 for heating or cooling the device. Heated or cooled water, oil or another appropriate fluid, such as saturated steam, may be circulated through the jacket via nozzles 118 and 120. In some embodiments, more than one jacket may be provided to provide separate heating and/or cooling zones. In such cases, the jackets may be isolated from each other and have separate nozzles. One such jacket may be used to heat a portion of the shell, while another such jacket may be used to cool another portion of the shell or to heat the other portion to a different temperature.

The WFE housing 100 also defines additional nozzles by which material may be introduced into and/or withdrawn from the interior chamber 114. When bottom feeding the WFE, material may be introduced via a first feed nozzle 122 located near the bottom of the installed rotor blade cartridge 400 (as most clearly seen in FIG. 11), and “bottoms” product may be withdrawn via a first bottoms nozzle 126. The term “bottoms” refers to end products remaining after at least evaporating a portion of the introduced feed material. The term bottoms may seem more appropriate to a top-fed WFE, where the bottoms product exits from the bottom or lower section of the WFE. However, in a bottom-fed WFE, the bottoms product exits near the top of the rotor blades. Nevertheless, these end products are referred to as bottoms, for consistency with industry terminology.

The WFE housing 100 may define a landing 128 that is sloped downward towards the first bottoms nozzle 126. Depending on the type of material introduced into the WFE and operating parameters, such as temperature and vacuum, maintained within the interior chamber 114, a helical blade cartridge and sufficient rotor shaft 200 rotational velocity (and possibly blade pitch) may be necessary to drive the material introduced through the first feed nozzle 122 and the evaporated bottoms product up the wall of the interior chamber 114. When the bottoms product reaches the sloped landing 128, the bottoms product is urged by gravity and by additional bottoms product driven by the blades out the first bottoms nozzle 126. Vapor may be withdrawn via a vapor nozzle 130 and/or via the first bottoms nozzle 122. This mode of operation is referred to as co-current, because the bottoms material and the vapor travel in the same direction.

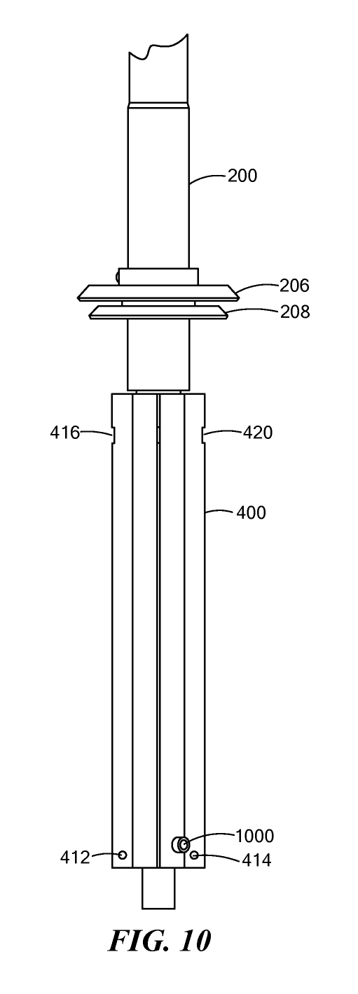

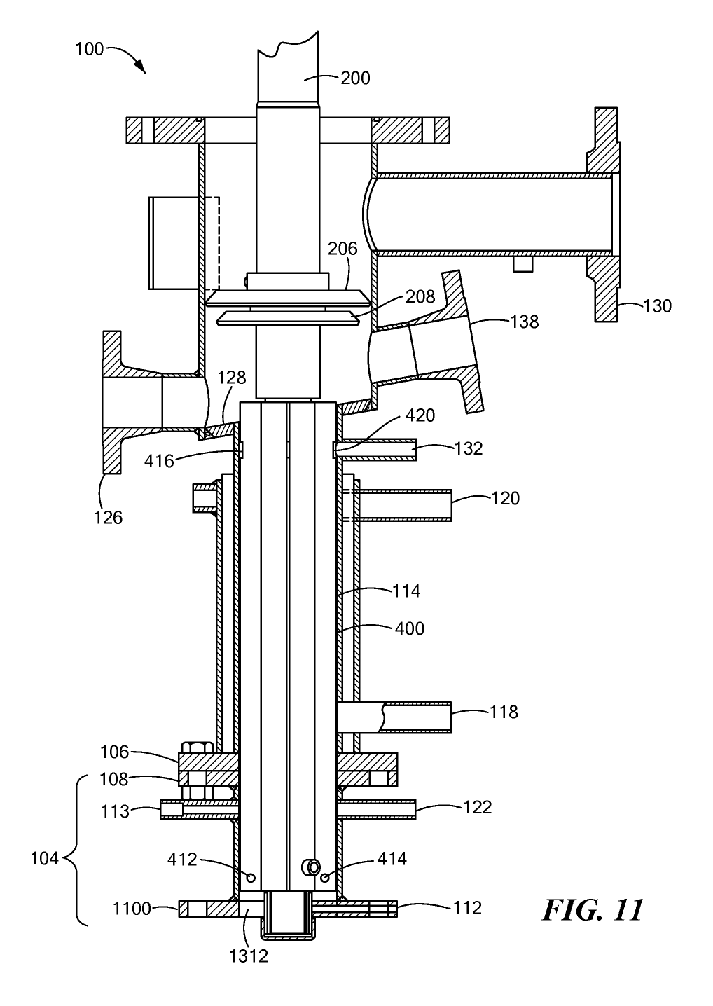

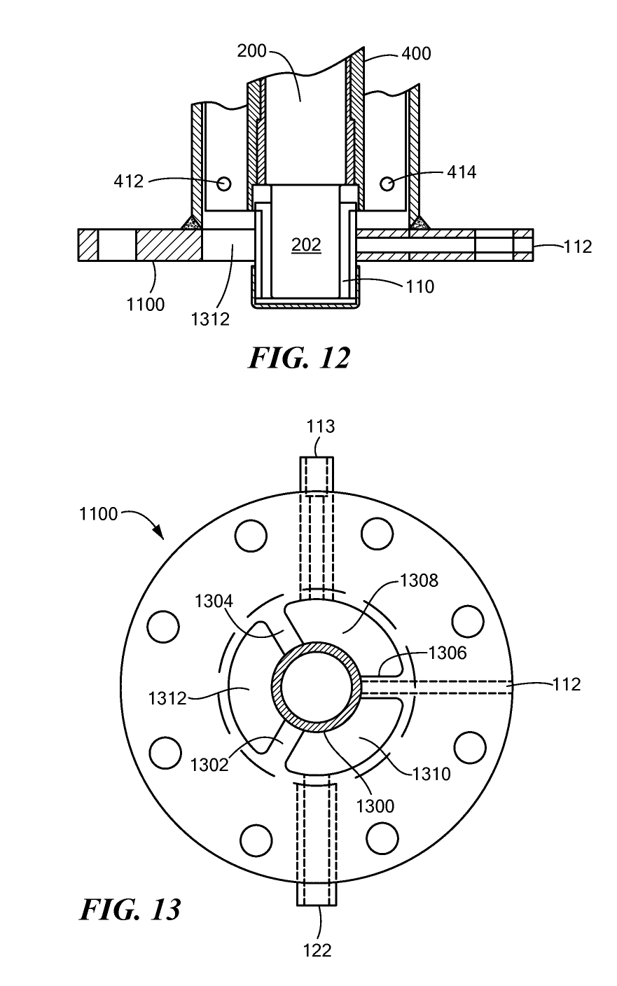

The lower section 104 of the WFE housing 100 includes a lower flange 1100. FIG. 12 is an enlarged view of the lower part of FIG. 11 showing the lower flange 1100 in more detail. FIG. 13 is a bottom view of the lower flange 1100. The lower flange 1100 includes a support 1300 for the bearing cup 110 (FIG. 1). The bearing cup support 1300 is connected to the remainder of the lower flange 1100 by three vanes 1302, 1304 and 1306. Openings 1308, 1310 and 1312 between pairs of the vanes 1302-1306 allow material to flow out the bottom of the WFE, when such flow is desired, such as when the WFE is top fed, as described below. (One such opening 1312 is visible in FIGS. 11 and 12.) However, when the WFE is bottom fed, these openings 1308-1312 should be blocked. FIG. 14 is a cross-sectional view of the flange 1100 with a bottom cap 1400 attached thereto to block the openings 1308-1312. (Mounting bolts are omitted for clarity.) Although the straight blade cartridge 400 is shown in FIG. 14, any suitable blade cartridge may be used when bottom feeding the WFE.

Returning to FIG. 2, one or more entrainment separators (exemplified by entrainment separators 206 and 208) may be installed on the rotor shaft 200 to prevent the vapor stream from carrying droplets or solid particles out the vapor nozzle 130. In addition, the rotating entrainment separators break up foams that may be created within the WFE. This is of particular advantage when processing surfactants and certain proteins, commonly used in food and pharmaceutical applications. Any suitable entrainment separator, such as a mesh, double blade, vane, chevron, labyrinth, paddle, ribbon blade or twisted helical ribbon blade or combination, may be used. Suitable entrainment separators are available from Artisan Industries, 73 Pond Street, Waltham, Mass. 02451. Each entrainment separator 206 and 208 may be attached to or include a sleeve 210 and 212, respectively, whose inside diameters accommodate the rotor shaft 200. A set screw 214 or other suitable fastener may be used to removably secure the entrainment separator(s) to the rotor shaft 200.

As best seen in FIG. 3, to facilitate entrainment separation, the section (referred to as an “entrainment separation section” 300) of the interior chamber 114 in which the entrainment separator(s) 206 and 208 reside may have a larger cross-sectional area than the cross-sectional area of the section of the interior chamber 114 housing the rotor blades. For example, if the entrainment separation section has a circular cross-section, the diameter 302 of the entrainment separation section is generally greater than the diameter 136 of the section of the interior chamber 114 housing the rotor blades. The cross-section of the entrainment separation section can, however, be any suitable shape to accommodate varying feed materials and conditions, such as partial vapor feed.

As vapor enters this entrainment separation section, the vapor slows down, thereby reducing the vapor's capacity to carry droplets or particles. Droplets or particles caught in the entrainment separation section drain back down the interior chamber 114. In general, higher gas flow rates are generated in vertical WFEs than in horizontal WFEs, owing to the smaller evaporation chambers. Therefore, relatively larger diameter 302 entrainment separation sections may be used in vertical WFEs than in horizontal machines to sufficiently to reduce vapor velocity. Optionally or alternatively, one or more non-rotating entrainment separation devices (not shown) may be installed in the entrainment separation section 300.

The integral entrainment separation provided by the disclosed WFE may eliminate the need for a conventional external entrainment separator generally employed by conventional WFEs, thereby reducing the number of connections in the overheads section. Having fewer connections in the vapor line reduces the number of possible vacuum leaks and corresponding maintenance requirements.

Referring now to FIG. 11, when top feeding the WFE, material may be introduced via a second feed nozzle 132 located near the top of the installed blade cartridge 400. Depending on the clearance between the edges of the blades and the inside wall of the interior chamber 114, notches may be required or desirable on the blades at about the elevation of the second feed nozzle 132. Otherwise, the introduced material may not be distributed adequately across the inside wall and may, instead, be channeled by pairs of adjacent blades directly to the bottom of the WFE. FIGS. 5, 7 and 9 show notches 412, 414, 416, 612, 612, 616, 812, 814 and 816 on the blades of the blade cartridges 400, 600 and 800, respectively.

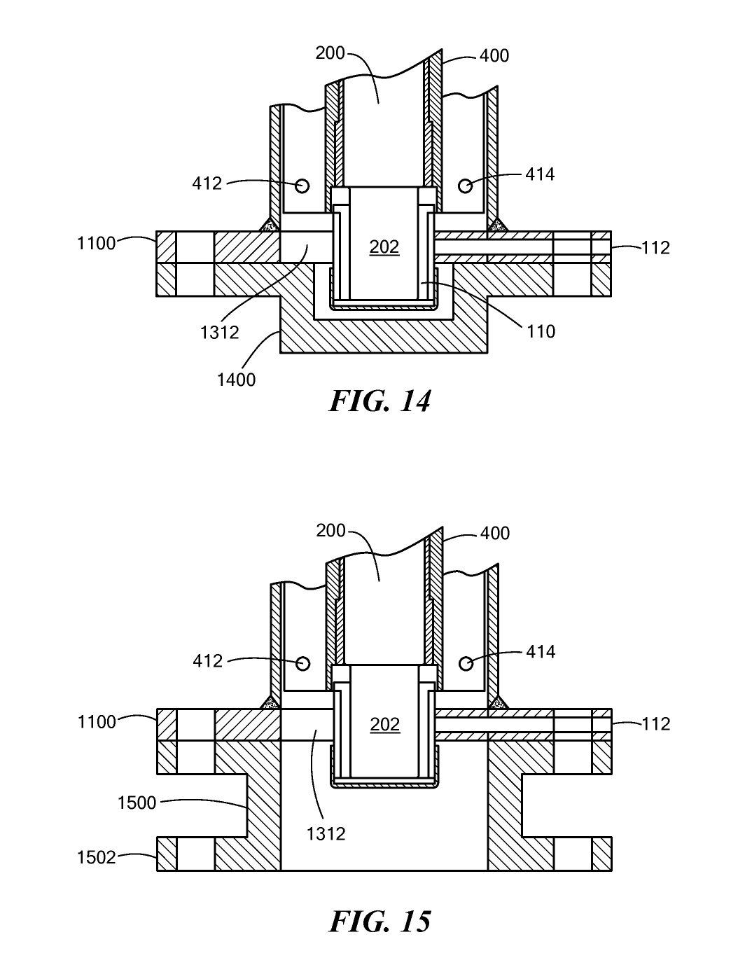

When top feeding the WFE, the bottoms product exits the WFE through the openings 1308-1312 (FIG. 13). In this case, rather than blocking the openings 1308-1312 as shown in FIG. 14, a bottoms adapter 1500, shown in FIG. 15, is attached to the WFE housing 100. The bottoms adapter 1500 includes a flange 1502, which defines a second bottoms nozzle 1504, by which the WFE may be connected to other equipment to receive the bottoms product. (Mounting bolts are omitted for clarity.) Vapor may be withdrawn via the vapor nozzle 130. This mode of operation is referred to as counter-current, because the bottoms material and the vapor travel in opposite directions. Optionally or alternatively, the vapor may be withdrawn via the second bottoms nozzle 1504. Although the straight blade cartridge 400 is shown in FIG. 15, any suitable blade cartridge may be used when top feeding the WFE.

Returning to FIG. 11, in some embodiments, the distance 134 between the top of the second feed nozzle 132 and the bottom of the vapor nozzle 130 is about one half the inside diameter 136 of the section of the interior chamber 114 housing the rotor blades. In other embodiments, this distance 134 is more or less than one-half the inside diameter 136.

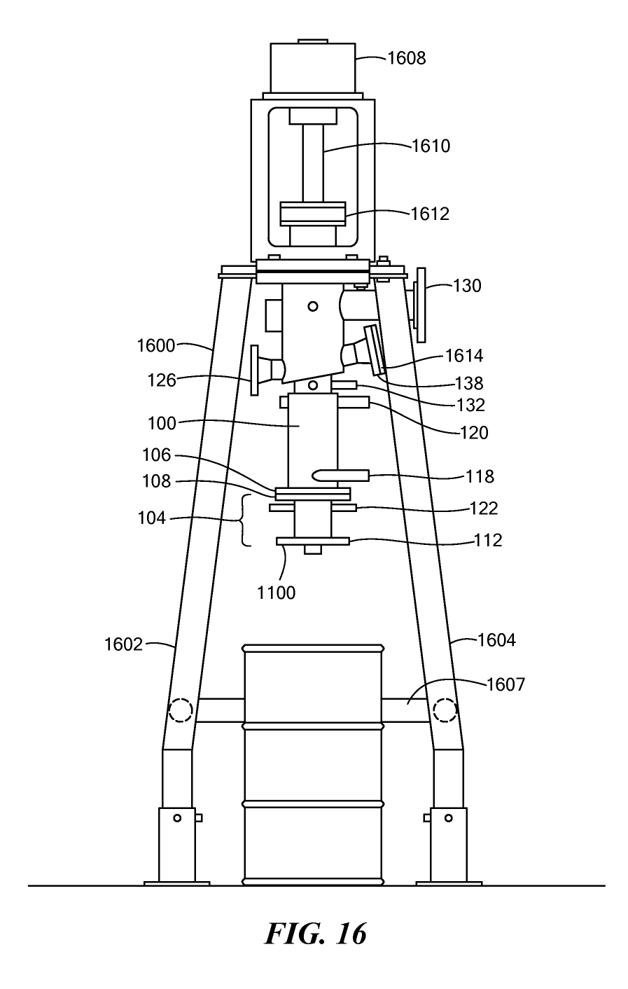

The WFE housing 100 and associated rotor shaft 200 may be mounted on any suitable frame or structure. FIG. 16 shows the WFE housing 100 mounted on an exemplary frame 1600, according to some embodiments of the present invention, which are particularly well suited for pilot or experimental uses. The frame 1600 may include four legs (two of which are visible at 1602 and 1604). The frame 1600 preferably supports the WFE housing 100 high enough so an appropriately sized drum 1606, or a positive displacement pump, may be positioned under the WFE (including any bottom cap, bottoms adapter or piping, not shown) to catch outflow that may occur when the bottom cap or bottoms adapter is removed to change blade cartridges or to clean or drain the WFE. (A standard 55-gallon drum is about 34.5 inches (880 mm) tall and just under about 24 inches (610 mm) in diameter.) Three side braces, exemplified by side brace 1607, may be included to make the frame 1600 rigid. Leaving one side of the frame 1600 unbraced facilitates installation and removal of the drum 1606.

As shown in FIG. 16, a motor drive 1608 may be attached to the frame 1600 and coupled to the rotor shaft 200 (only an upper portion of which is visible at 1610) to drive the rotor shaft 200. The upper portion of the rotor shaft is supported by a rigid coupling and a steady rest bearing incorporated into a mechanical seal assembly 1612 to isolate the interior chamber 114 from the ambient, thereby allowing the WFE to operate under vacuum when desired. Thus, both the upper and lower portions of the rotor shaft 200 are held by bearings, thereby reducing shaft whip. Reduced shaft whip provides a more uniform thin film thickness on the WFE wall, resulting in better heat transfer. The weight of the rotor shaft 200 is borne by the upper bearing. Thus, the lower bearing may be removed, such as to change blade cartridges, without providing additional support to prevent the rotor shaft 200 from dislodging.

The WFE housing 100 may define an additional nozzle 138 (best seen in FIG. 1). The additional nozzle 138 may be several times larger in diameter than the first feed nozzle 122. Optionally, the additional nozzle 138 may be fitted with a sight glass 1614 (FIG. 16), so interior operation of the WFE (such as operation of the entrainment separators, bottoms productions in bottom-feeding mode or possible overflow in top-feeding mode) may be observed. The additional nozzle 138 may be sloped to provide optimum viewing of the landing 128, the bottom of the entrainment separator 208 or the exit path to the first bottoms nozzle 126.

In some modes of operation, the additional nozzle 138 may be used as a feed nozzle, thereby feeding directly into the entrainment section 300 of the WFE. This may be useful when feeding partial vapor into the WFE or when feeding a product that partly flashes upon entering the device.

The WFE configuration shown in FIG. 16 facilitates experimenting with various feed modes (top feeding or bottom feeding, feeding the section of the interior chamber 114 housing the rotor blades or feeding directly into the entrainment section 300), blade configurations, blade rotation speeds, vapor withdrawal (co-current or counter-current), temperatures, etc. The replaceable blade cartridge allows changing the blade configuration, pitch and direction of thin film displacement for different modes of operation. The blade cartridge may be easily and quickly replaced, without removing the rotor shaft 200, by simply removing the bolts that secure the flanges 106 and 108, thereby freeing the bottom section 104 of the WFE housing 200 from the top section 102 of the WFE housing.

In contrast, prior art WFEs require removing the rotor shaft to change rotor blades. This typically involves disassembling a drive unit, as well as seals and bearings, from the WFE assembly.

Similarly, the integral entrainment separation may be easily modified to accommodate various entrainment separator designs suited for different separation applications. Optionally, the entrainment section 300 (FIG. 3) of the WFE housing 100 may be divided into two sections joined by an additional pair of flanges (not shown) to facilitate replacing the entrainment separators 206 and 208.

As noted, the WFE may be top fed or bottom fed, and either co-current or counter-current operation may be employed. Counter-current mode of operation is generally desirable for higher viscosity applications.

Bottom feeding creates more back-mixing and hold-up of process material in the WFE, which is advantageous for certain chemical reaction applications where thin film processing of semi-viscous materials is desired. Bottom feeding also provides an operator with better control over residence time. When operating in a co-current bottom fed mode of operation, dry spots commonly associated with conventional modes of operation are eliminated or significantly reduced, because the rate at which product is lifted from the bottom of the WFE and spread on the walls is controllable by appropriate selection of blade shape, pitch and rotational velocity. In contrast, in conventional top-fed WFEs, the rate at which product progresses down the walls is determined by the product's physical properties and gravity, neither of which may be under an operator's control.

When bottom feeding, some pooling of feed material may occur in the bottom of the WFE. However, this pooling may provide better back-mixing of the material, which is believed to provide an advantage in certain chemical reactions, such as where plug flow is deemed inefficient compared to other technologies that provide more rigorous back mixing, such as in continuous stirred tank reactors (CSTRs). For example, when feed material is not consistent over time, increased mixing time may provide a more uniform end product. On the other hand, top feeding provides processing closer to plug flow reactors (PFRs).

In accordance with exemplary embodiments, a vertically axised wiped thin-film evaporator and method for using the same are provided. While specific values chosen for these embodiments are recited, it is to be understood that, within the scope of the invention, the values of all of parameters may vary over wide ranges to suit different applications. While the invention is described through the above-described exemplary embodiments, it will be understood by those of ordinary skill in the art that modifications to, and variations of, the illustrated embodiments may be made without departing from the inventive concepts disclosed herein. For example, although removable blade cartridges have been described, production WFEs may or may not include replaceable blade cartridges. Furthermore, disclosed aspects, or portions of these aspects, may be combined in ways not listed above. Accordingly, the invention should not be viewed as being limited to the disclosed embodiments.

What is claimed is:

1. A vertically axised, rotary wiped thin-film evaporator, comprising:
a vertically oriented vessel defining a vertically-oriented cylindrical interior section and an interior entrainment separation section above and in fluid communication with the cylindrical interior section, the interior entrainment separation section having a larger cross-sectional area than the cylindrical internal section;
a first feed nozzle in fluid communication with the cylindrical interior section;
a first discharge nozzle in fluid communication with the cylindrical interior section;
a jacket surrounding at least a portion of the cylindrical interior section and configured to transfer heat between a fluid flowing through the jacket and the cylindrical interior section;
at least two heat exchange fluid nozzles in fluid communication with the jacket;
a vertically-oriented shaft extending through the entrainment separation section and the cylindrical interior section and configured to rotate therewithin;
at least one elongated rotor blade disposed within the cylindrical interior section and aligned with and attached to the vertically-oriented shaft for rotation therewith; and
at least one entrainment separator disposed within the interior entrainment separation section and attached to the vertically-oriented shaft for rotation therewith.

2. A vertically axised, rotary wiped thin-film evaporator according to claim 1, wherein the at least one entrainment separator comprises at least one of a mesh, a double blade, a vane, a chevron, a labyrinth, a paddle, a ribbon blade and a twisted helical ribbon blade.

3. A vertically axised, rotary wiped thin-film evaporator according to claim 1, wherein the at least one entrainment separator is detachably attached to the vertically-oriented shaft.

4. A vertically axised, rotary wiped thin-film evaporator according to claim 1, wherein the first feed nozzle is disposed higher than the first discharge nozzle.

5. A vertically axised, rotary wiped thin-film evaporator according to claim 1, wherein the first feed nozzle is disposed lower than the first discharge nozzle.

6. A vertically axised, rotary wiped thin-film evaporator according to claim 1, wherein the first discharge nozzle is in fluid communication with the cylindrical interior section via at least a portion of the interior entrainment separation section.

7. A vertically axised, rotary thin-film evaporator according to claim 1, wherein a bottom of the interior entrainment separation section is sloped downward toward the first discharge nozzle.

8. A vertically axised, rotary wiped thin-film evaporator according to claim 1, wherein:
the at least one elongated blade has a top end and a bottom end;
the first feed nozzle is disposed closer to the bottom end of the elongated blade than to the top end of the elongated blade;
the first discharge nozzle is disposed closer to the top end of the elongated blade than to the bottom end of the elongated blade; and further comprising:
a second feed nozzle in fluid communication with the cylindrical interior section and disposed closer to the top end of the elongated blade than to the bottom end of the elongated blade; and
a second discharge nozzle in fluid communication with the cylindrical interior section and disposed closer to the bottom end of the elongated blade than to the top end of the elongated blade.

9. A vertically axised, rotary wiped thin-film evaporator according to claim 8, further comprising a third feed nozzle in fluid communication with the cylindrical interior section below the at least one entrainment separator and disposed closer to the top end of the elongated blade than to the bottom end of the elongated blade.

10. A vertically axised, rotary wiped thin-film evaporator according to claim 9, wherein the third feed nozzle is sloped downward toward the cylindrical interior section.

11. A vertically axised, rotary wiped thin-film evaporator according to claim 10, further comprising a viewing glass attached to the third feed nozzle.

12. A vertically axised, rotary wiped thin-film evaporator according to claim 9, further comprising:
a stand to which the vertically oriented vessel is attached so as to provide at least about 35 inches of clearance below the vertically oriented vessel, the stand absent any horizontal brace below about 36 inches above the base of the stand on at least one side thereof; and
a motor attached to the stand and mechanically coupled to the vertically-oriented shaft to rotate the shaft.

13. A vertically axised, rotary wiped thin-film evaporator according to claim 1, further comprising a vapor discharge nozzle in fluid communication with the interior entrainment separation section above the at least one entrainment separator.

14. A vertically axised, rotary wiped thin-film evaporator according to claim 1, wherein the at least one elongated blade comprises a removable blade cartridge releasably attached to the vertically-oriented shaft, such that the removable blade cartridge is replaceable without removing the vertically-oriented shaft.

15. A vertically axised, rotary wiped thin-film evaporator according to claim 14, further comprising an upper bearing rotatably attached to the vertically-oriented shaft above the at least one elongated rotor blade, the upper bearing being configured to support at least the combined weight of the vertically-oriented shaft and the removable blade cartridge.

16. A vertically axised, rotary wiped thin-film evaporator according to claim 1, wherein the at least one elongated rotor blade comprises a helical rotor blade having a blade pitch greater at the top of the rotor blade than at the bottom of the rotor blade.

17. A method for bottom-feeding a vertically axised, rotary wiped thin-film evaporator, the method comprising:
rotating a rotor blade disposed within the rotary thin-film evaporator;
introducing a feed fluid into the rotary thin-film evaporator closer to a bottom end of the rotating rotor blade than to a top end of the rotating rotor blade;
heating an inside wall of the rotary thin-film evaporator;
driving at least a portion of the feed fluid up the inside wall at least partly through action of the rotating rotor blade; and
withdrawing a bottoms product from the rotary thin-film evaporator closer to the top end of the rotating rotor blade than to the bottom end of the rotating rotor blade.

18. A method according to claim 17, wherein rotating the rotor blade comprises rotating a helical rotor blade.

19. A method according to claim 17, wherein rotating the rotor blade comprises rotating a helical rotor blade having a blade pitch greater at the top of the rotor blade than at the bottom of the rotor blade.

20. A method according to claim 17, further comprising rotating an entrainment separator attached to a common shaft with the rotor blade and disposed within the rotary thin-film evaporator.

21. A method according to claim 20, further comprising withdrawing a vapor from the rotary thin-film evaporator via a nozzle disposed higher than the entrainment separator.
